(19) United States
(12) Patent Application Publication
(10) Pub. No.: US 2017/0136478 A1
(43) Pub. Date: May 18, 2017

(54) PUMP CONTAINER FOR DISCHARGING CAPSULES

(71) Applicant: YONWOO CO., LTD., Incheon (KR)

(72) Inventors: Seo-Hui JUNG, Incheon (KR); Ki-Young HAM, Incheon (KR)

(21) Appl. No.: 15/318,944

(22) PCT Filed: May 18, 2015
(86) PCT No.: PCT/KR2015/004943

§ 371 Date: Dec. 14, 2016

(30) Foreign Application Priority Data
Jun. 16, 2014 (KR) 10-2014-0072730

(51) Int. Cl. B05B 11/00; F04B 53/10; F04B 23/02; F04B 53/16; A45D 33/02; F04B 19/22

(52) U.S. Cl. CPC B05B 11/3069; A45D 33/02; F04B 19/22; F04B 23/028; F04B 53/16; F04B 53/10; B05B 11/0032; B05B 11/0048; B05B 11/3001; B05B 11/3045; B05B 11/3052

(57) ABSTRACT

The present invention disclosed herein relates to a pump container for discharging capsules, in which an opening/closing plate of a valve member is coupled to the inner peripheral surface of a valve body through a rotary support to rotate up and down so as to open/close a content inflow hole and the upper end of a content movement tube, such that encapsulated granule contents can be discharged, without rupturing, during a pumping operation of a pumping member.

### BACKGROUND OF THE DISCLOSURE

The present invention disclosed herein relates to a pump container for discharging capsules, in which an opening/closing plate of a valve member is coupled to the inner peripheral surface of a valve body through a rotary support to rotate up and down so as to open/close a content inflow hole and an upper end of a content movement tube, such that encapsulated granule contents can be discharged, without rupturing, during a pumping operation of a pumping member.

Generally, among functional cosmetics, there are granule type cosmetics containing capsules where other ingredients are contained as a main component. In case of having to mix two incompatible ingredients such as vitamin A or vitamin C, or to add materials that tend to be spoiled easily if they are put together, these granule type cosmetics have specific ingredients which are put in capsules and mixed with basic ingredients of cosmetics.

A container containing encapsulated granule contents as the above is disclosed in the registered utility model No. 20-0180852. (Hereafter called as the registered utility model)

The registered utility model relates to a container, the container comprises a container body receiving encapsulated granule contents, a pump which is attached to an outlet part of the container body and thereby discharges the contents, a head having a nozzle, and a discharging passage connecting the outside through the pump and the head from the container body, wherein a net is installed to the passage for pulverize the encapsulated granule contents.

The registered utility model is configured in a way that granule type cosmetics pass through and ruptured to be mixed with main ingredients and then discharged when the contents are discharged. However, a user cannot confirm whether the granule type cosmetics are ruptured and mixed during the discharging process of the contents or the granule type cosmetics are discharged after being mixed with main ingredients already ruptured. Hence, there arises a problem that the user cannot trust effectiveness of the product for fear that the contents thereof should be spoiled.

Meanwhile, in case cosmetics are discharged according to a pumping operation through a pumping structure such as the registered utility model, it is possible that there arises a situation that a part of granular cosmetics is ruptured while passing through a check valve, e.g. a ball valve installed inside a cylinder of a pump. Due to this, cosmetic products may be degraded in terms of effectiveness.

Accordingly, there increases a demand for a pumping structure which makes it possible to discharge granule type cosmetics with granules not being ruptured, such that a user can mix and use cosmetics while confirming the intactness of granule type cosmetics directly with her own eyes.

### SUMMARY OF THE DISCLOSURE

The present invention is devised to solve said problems above, and its goal is to provide a pump container for discharging capsules, wherein an opening/closing plate of a valve member is coupled to the inner peripheral surface of a valve body through a rotary support to rotate up and down so as to open/close a content inflow hole and the upper end of a content movement tube, such that encapsulated granule contents can be discharged, without rupturing, during a pumping operation of a pumping member.

To solve such problems described in the above, a pump container for discharging capsules according to the present invention comprises: a container body storing liquid type and encapsulated granule contents, and having a volume reduced according to the contents use; a support body coupled to an upper portion of the container body and supporting a pumping member, further comprising a cylinder where a content inflow hole is formed such that the contents stored in the container body can flow in; a pumping member coupled to the support body and performing a pumping operation such that the contents stored in the container body can be discharged to the outside, further including a content moving tube which forms a passage where the contents flowing into the cylinder can move to an upper portion thereof, a coupling part which extends to an upper portion of the content moving tube and is coupled to an inner side of a button member, a stem which consists of a valve securing part formed at an inner side of the coupling part such that a second valve member, which opens/closes an upper end of the content moving tube, can be secured, and a sealing cap which is coupled encasing an lower portion of the content moving tube and closely contacted to an inner wall of the cylinder, thereby changing an inner pressure of the cylinder according to the ascent/descent; and a button member which is coupled to an upper portion of the pumping member, delivering the pressure formed according to a user's pressurization to the pumping member, and thereby induces a pumping operation of the pumping member, further comprising a content discharging hole such that the contents can be discharged by a pumping operation of the pumping member.

At the cylinder is installed a first valve member which is disposed at an upper portion of the content inflow hole and opens/closes the content inflow hole according to the change of inner pressure of the cylinder, and at the valve securing part is installed a second valve member which opens/closes an upper end of the content moving tube according to the change of inner pressure of the cylinder.

The first valve member and the second valve member are configured to get one side to rotate up and down with the other side fixed so as to open/close an upper end of the content inflow hole and the content moving tube, wherein the diameter of the content moving tube is bigger than the size of encapsulated granule contents, such that the encapsulated granule contents can be discharged with capsules in the contents not being ruptured.

Furthermore, the first valve member is configured to include a first valve body which is coupled with a combined fit, encasing an inner peripheral surface of the cylinder, and forms a hollow, and also a first opening/closing plate which is coupled at one side of an inner peripheral surface of the first valve body to be able to be rotated up and down by means of a first rotary support bar and thereby opens/closes the content inflow hole according to an upward/downward rotation.

Furthermore, the second valve member includes a second valve body which is coupled with a combined fit, encasing an inner peripheral surface of the coupling part, and forms a hollow, and a second opening/closing plate which is coupled at one side of an inner peripheral surface of the second valve body to be able to be rotated up and down by means of a second rotary support bar, and thereby opens/closes the content inflow hole according to an upward/downward rotation.

Furthermore, at the button member is coupled a sealing member capable of being attached/detached to the content discharging hole according to the use of contents, wherein the sealing member comprises an insertion part which opens/closes the content discharging hole according to the insertion to/withdrawal from the content discharging hole, and a handle part which extends from the insertion part and can gripped by a user.

As described above, the present invention is provided with an opening/closing plate of a valve member which is coupled to the inner peripheral surface of a valve body through a rotary support bar to rotate up and down so as to open/close a content inflow hole and the upper end of a content movement tube, such that encapsulated granule contents can be discharged, without capsules being ruptured, during a pumping operation of a pumping member.

### BRIEF DESCRIPTION OF THE DRAWINGS

FIG. 1 is an exploded perspective view illustrating a configuration of a pump container for discharging capsules according to an exemplary embodiment of the present invention.

FIG. 2 is an assembled perspective view illustrating a configuration of a pump container for discharging capsules according to an exemplary embodiment of the present invention.

FIG. 3 is a cross-sectional view illustrating a configuration of a pump container for discharging capsules according to an exemplary embodiment of the present invention.

FIG. 4 is an explanatory drawing illustrating a configuration of a first and a second valve member of a pump container for discharging capsules according to an exemplary embodiment of the present invention.

FIGS. 5 to 7 are explanatory drawings illustrating a discharging process of a pump container for discharging capsules according to an exemplary embodiment of the present invention.

### DETAILED DESCRIPTION

Hereinafter, exemplary embodiments of the present invention will be described in detail with reference to the accompanying drawings. The same reference numerals provided in the drawings indicate the same members.

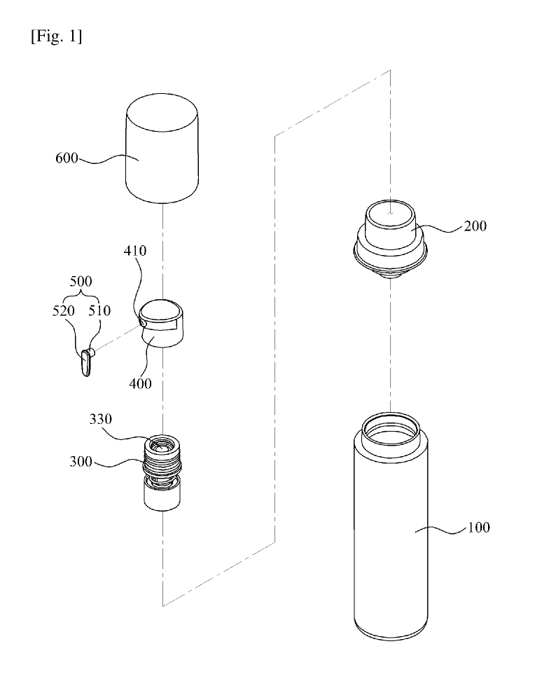

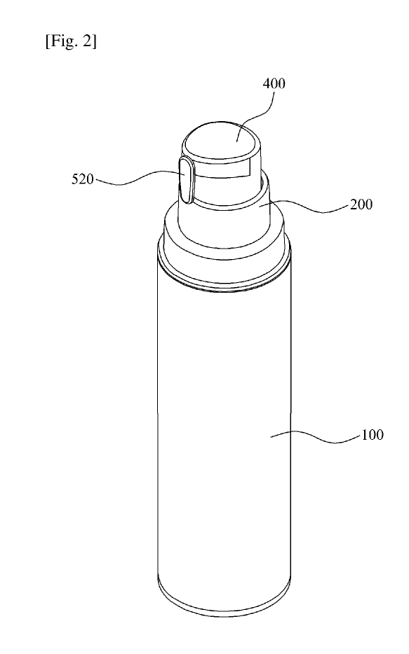

FIG. 1 is an exploded perspective view illustrating a configuration of a pump container for discharging capsules according to an exemplary embodiment of the present invention. FIG. 2 is an assembled perspective view illustrating a configuration of a pump container for discharging capsules according to an exemplary embodiment of the present invention.

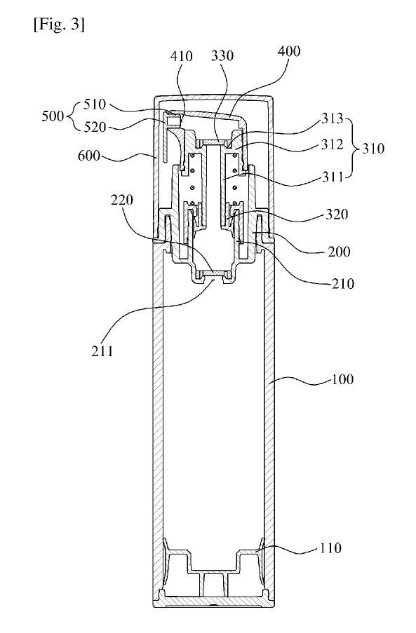

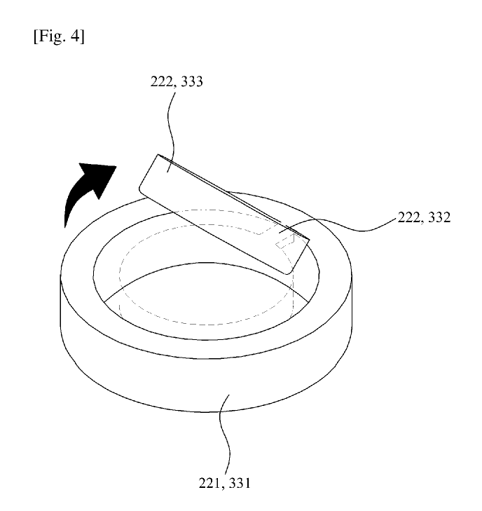

FIG. 3 is a cross-sectional view illustrating a configuration of a pump container for discharging capsules according to an exemplary embodiment of the present invention. FIG. 4 is an explanatory drawing illustrating a configuration of a first and a second valve member of a pump container for discharging capsules according to an exemplary embodiment of the present invention.

Referring to FIGS. 1 to 4, a pump container for discharging capsules according to an exemplary embodiment of the present invention may include a tube body 100, a support body 200, a pumping member 300, and a button member 400.

The tube body 100 storing liquid type contents or encapsulated granule contents (Hereafter called as “contents”) is composed of a piston 110 at an inner lower portion which ascends according to the use of contents. In the drawings of the present invention, a piston 110 is installed to the container body 100; however, it is possible various types of container like a tube container 100 can be configured, and also possible that a pouch receiving contents can be coupled at an inner side of the container body 100.

The support body 200, coupled to an upper portion of the container body 100 and supporting a pumping member 300, comprises a cylinder 210 at a center portion thereof such that the pumping member 300 can be coupled and perform a pumping operation, wherein a content inflow hole 211 is installed at a lower portion of the cylinder 210 such that the contents stored in the container body 100 can flow in, and at an upper portion of the content inflow hole 211 is installed a first valve member 220 which opens/closes the content inflow hole 211 according to the change of inner pressure of the cylinder 210.

In the present invention, the first valve member 220 is configured to get one side thereof to rotate up and down with the other side fixed and thereby to open/close the content inflow hole 211. To do this, a cylinder 210 comprises a first valve body 221 which is coupled with a combined fit, encasing an inner peripheral surface of the cylinder 210 at an inner lower portion of the cylinder 210, and forms a hollow, and a first opening/closing plate 223 which is coupled to one side to be able to rotate up and down through a first rotary support bar 222 and opens/closes the content inflow hole 211 according to the upward/downward rotation.

The first valve member 223 is different from a conventional check valve in that a first opening/closing plate 223 rotates to upward direction and opens the content inflow hole 211 when the contents stored in the container body 100 flow in through the content inflow hole 223. Due to this, it is possible that encapsulated granule contents can flow into the inside of the cylinder 210 without being ruptured.

Meanwhile, an over cap 600 is coupled at the support body 200 for preventing a malfunction of a button member 400.

The pumping member 300 is coupled to the cylinder 210 of the support body 200 and performs a pumping operation so as to discharge the contents stored in the container body 100, further including a stem 310, a seal cap 320, and a second valve member 330.

The stem 310 has a button member 400 coupled at an upper portion thereof and a seal cap 320 coupled at a lower portion thereof, thereby moving according to the pressurization of the button member 400 and then allowing the ascent/descent of the seal cap 320. The seal cap 320 further comprises a content moving tube 311 which forms a passage where the contents flowing to the cylinder 210 can move to an upper portion, a coupling part 312 which extends to an upper portion of the content moving tube 311 and is coupled to an inner side of the button member 400, and a valve securing part 313 which is formed at an inner side of the coupling part 312 such that a second valve member 330, opening/closing an upper end of the content moving tube 311, can be secured In the present invention.

In order for the encapsulated granule contents not to be ruptured during the process of moving, the diameter of the content moving tube 311 is preferably bigger than the size of capsules.

The seal cap 320 is coupled encasing a lower portion of the content moving tube 311, is contacted to an inner wall of the cylinder, and thereby changes an inner pressure of the cylinder 210. When the button member 400 is pressed, the seal cap 320 descends according to the movement of the stem 310 and leads the contents flowing into the inside of the cylinder 210 to move to a content discharging hole 410 through the content moving tube 311. Meanwhile, when the button member 400 is not pressed, the seal cap 320 ascends according to the movement of the stem 310 and allows the contents stored in the content body 100 to flow into the inside of the cylinder 210.

The second valve member 330 is secured to a valve securing part 313 formed at an inner side of the coupling part 312, and opens/closes an upper end of the content moving tube 311 according to the change of the inner pressure of the cylinder 210. In the present invention, the second valve member 330 is configured to get one side to rotate up and down with the other side fixed and to open/close an upper end of the content moving tube 311. To do this, the second valve member 330 comprises a second valve body 331 which encases an inner peripheral surface of the coupling part 312, is coupled with a combined fit to the valve securing part 313, and forms a hollow, and a second opening/closing plate 333 which is coupled so as to be rotated up and down through a second rotary support bar 332 at one side of the inner peripheral surface of the second valve body 331 and opens/closes an upper end of the content moving tube 311 according to the upward/downward rotation thereof.

The second valve member 330, unlike conventional ordinary check valves, makes a second opening/closing plate 333 rotate in an upper direction and open an upper end of the content moving tube 311 when the contents flowing into the cylinder 210 move to an upper portion thereof through the content moving tube 311. Due to this, the encapsulated granule contents can be discharged without being ruptured through the content discharging hole 410 to the outside.

Meanwhile, the pumping member 300, among the ordinary structures of a stem, a piston rod coupled to a lower portion of the stem, and a seal cap coupled encasing an outer peripheral surface of the piston rod at a lower portion of the piston rod and moving along an inner wall of the cylinder, excludes a piston rod and instead and includes a pump structure such that the seal cap can be coupled to an outer peripheral surface of the stem. Therefore, it is possible to save the expense by reducing the number of parts and also possible to discharge the encapsulated granule contents without capsules being ruptured because the contents can move directly to the content moving tube of the stem, not move through a content inflow outlet formed at an inner side of the piston rod.

The button member 400, which is coupled to an upper portion of the pumping member 300 and delivers pressure according to user's pressurization to the pumping member 300, and thereby induces a pumping operation of the pumping member 300, comprises a content discharging hole 410 at a side thereof such that contents can be discharged by the pumping operation of the pumping member 300.

In the present invention, a sealing member 500, which can be attached/detached to the content discharging hole 410 according to the use of contents, is coupled at the button member 400. The sealing member 500 comprises an insertion part 510 which opens/closes the content discharging hole 410 according to the insertion to or withdrawal from the content discharging hole 410, and a handle part 520 which extends from the insertion part 510 and can be gripped by a user.

The sealing member 500 blocks leakage of contents or prevents air or other foreign matters from flowing into the content discharging hole 410, and allows the discharge of contents when detached from the content discharging hole 410.

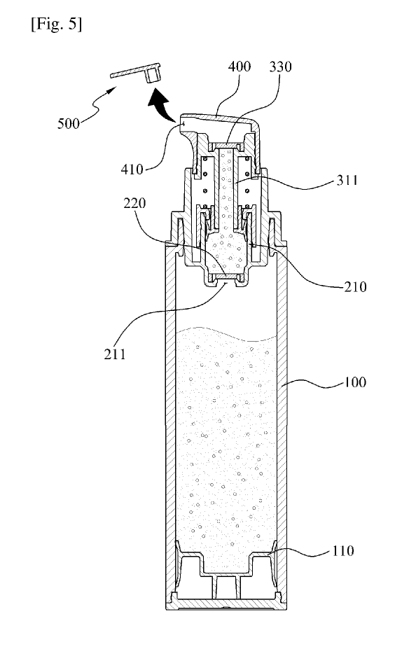

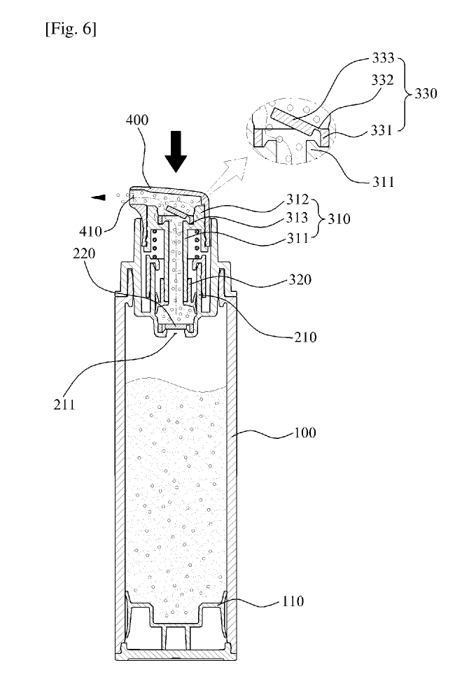

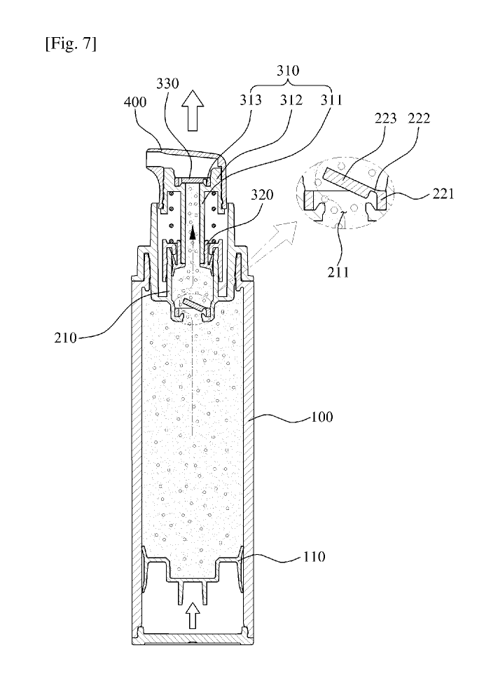

Hereinafter, referring FIGS. 5 to 7, an operational state of a pump container for discharging capsules according to an exemplary embodiment of the present invention will be described. FIGS. 5 to 7 are explanatory drawings illustrating a discharging process of contents in a pump container for discharging capsules according to an exemplary embodiment of the present invention.

Referring FIGS. 5 to 7, when a user wants to discharge and use contents at a state that a cylinder 210 holds contents which has flowed into the inside thereof, a pump container for discharging capsules according to an exemplary embodiment of the present invention firstly detaches the sealing member 500 closing the content discharging hole 410 from the content discharging hole 410 and then pressurizes the button member 400.

As the above when the button member 400 is pressurized, the pumping operation of the pumping member 300 disposed at a lower portion thereof. Due to this, contents ascends through the content moving tube 311 by the pressure arising inside the cylinder 210, and then the second valve member 330 opens an upper end of the content moving tube 311 by the pressure caused by the ascending contents and discharge the contents through the content discharging hole 410.

At this moment, a second opening/closing plate 333 of a second valve member 330 rotate and opens an upper end of the content moving tube 311. Due to this, encapsulated granule contents can be discharged without being ruptured to the outside through the content discharging hole 410.

Next, if the button member 400 is released from pressurization, the button member 400 ascends by an elastic force of a spring composed of the pumping member 300. Due to this, a first valve member 220 open a content inflow hole 211 by the pressure arising inside the cylinder 210, and thereby the contents stored in the container body 100 are discharged to the inside of the cylinder 210 through the content inflow hole 211.

At this moment, a first opening/closing plate 333 of the first valve member 220 rotates to an upward direction and opens the content inflow hole 211. Due to this, it is possible that encapsulated granule contents be moved to the inside of the cylinder 210 without encapsulated granule contents being ruptured.

As previously described, the present invention, unlike conventional check valves, has a structure where the first opening/closing plate 223 and the second opening/closing plate 333 rotate to an upward direction and opens upper ends of the content inflow hole 211 and the content moving tube 311. Therefore, it is possible that a user can discharge contents without rupturing encapsulated granules and then ruptures the discharged capsules to mix with encapsulated granule contents for applying, thereby leading to increase the reliability of the product.

As described above, optimal embodiments have been disclosed in the drawings and the specification. Although specific terms have been used herein, these are only intended to describe the present invention and are not intended to limit the meanings of the terms or to restrict the scope of the present invention as disclosed in the accompanying claims. Therefore, those skilled in the art will appreciate that various modifications and other equivalent embodiments are possible from the above embodiments. Therefore, the scope of the present invention should be defined by the technical spirit of the accompanying claims.

1. A pump container for discharging capsules comprising:
a container body storing liquid type and encapsulated granule contents, and having a volume reduced according to the use of contents;
a support body coupled to an upper portion of the container body and supporting a pumping member, further comprising a cylinder where a content inflow hole is formed such that the contents stored in the container body can flow in;
a pumping member coupled to the support body and performing a pumping operation such that the contents stored in the container body can be discharged to the outside, further including a content moving tube forming a passage where the contents flowing into the cylinder can move to an upper portion thereof, a coupling part extending to an upper portion of the content moving tube and coupled to an inner side of a button member, a stem consisting of a valve securing part formed at an inner side of the coupling part such that a second valve member opening/closing an upper end of the content moving tube can be secured, and a sealing cap which is coupled encasing an lower portion of the content moving tube and is closely contacted to an inner wall of the cylinder, thereby changing an inner pressure of the cylinder according to the ascent/descent; and
a button member coupled to an upper portion of the pumping member, delivering the pressure formed according to a user's pressurization to the pumping member, and thereby inducing a pumping operation of the pumping member, further comprising a content discharging hole such that the contents can be discharged by a pumping operation of the pumping member,
wherein at the cylinder is installed a first valve member disposed at an upper portion of the content inflow hole and opening/closing the content inflow hole according to the change of inner pressure of the cylinder, and at the valve securing part is installed a second valve member which opens/closes an upper end of the content moving tube according to the change of inner pressure of the cylinder,
wherein the first valve member and the second valve member are configured to get one side to rotate up and down with the other side fixed so as to open/close an upper end of the content inflow hole and the content moving tube, wherein the diameter of the content moving tube is bigger than the size of encapsulated granule contents, such that the encapsulated granule contents can be discharged with capsules in the contents not being ruptured.

2. The pump container for discharging capsules of claim 1,
wherein the first valve member includes a first valve body coupled with a combined fit, encasing an inner peripheral surface of the cylinder, and forming a hollow, and a first opening/closing plate coupled at one side of an inner peripheral surface of the first valve body to be able to be rotated up and down by means of a first rotary support bar and thereby opening/closing the content inflow hole according to an upward/downward rotation.

3. The pump container for discharging capsules of claim 1,
wherein the second valve member includes a second valve body coupled with a combined fit, encasing an inner peripheral surface of the coupling part and forming a hollow, and a second opening/closing plate coupled at one side of an inner peripheral surface of the second valve body to be able to be rotated up and down by means of a second rotary support bar, and thereby opening/closing the content inflow hole according to an upward/downward rotation.

4. The pump container for discharging capsules of claim 1,
wherein at the button member is coupled a sealing member capable of being attached/detached to the content discharging hole according to the use of contents, wherein the sealing member comprises an insertion part opening/closing the content discharging hole according to the insertion to/withdrawal from the content discharging hole, and a handle part extending from the insertion part and gripped by a user.
